(19) United States
(12) Patent Application Publication
(10) Pub. No.: US 2022/0321350 A1
(43) Pub. Date: Oct. 6, 2022

(54) SYSTEM FOR VOICE AUTHENTICATION THROUGH VOICE RECOGNITION AND VOICEPRINT RECOGNITION

(71) Applicant: SOLUGATE INC., Seoul (KR)

(72) Inventors: Sung Tae MIN, Seoul (KR); Jun Ho PARK, Yangju-si (KR); Chan Seon PARK, Gunpo-si (KR)

(73) Assignee: SOLUGATE INC., Seoul (KR)

(21) Appl. No.: 17/489,240

(22) Filed: Sep. 29, 2021

(30) Foreign Application Priority Data
Apr. 6, 2021 (KR) 10-2021-0044820

(51) Int. Cl. H04L 9/32; G10L 17/06; G10L 17/04; H04L 29/06; H04L 9/30

(52) U.S. Cl. CPC H04L 9/3231; G10L 17/06; G10L 17/04; H04L 63/0861; H04L 9/30; H04L 9/3239; H04L 2209/38

(57) ABSTRACT

Disclosed is a voice authentication method through voice recognition and voiceprint recognition by a server. The voice authentication method includes receiving voice information from a user terminal, generating voiceprint information about a user based on the voice information, when a decentralized ID is issued based on a block chain, generating a private key based on the voiceprint information, and generating a public key based on public information of the user, and performing authentication for the user to generate authentication result information when a request for authentication for the user is received from an external device.

### CROSS-REFERENCE TO RELATED APPLICATIONS

A claim for priority under 35 U.S.C. § 119 is made to Korean Patent Application No. 10-2021-0044820 filed on Apr. 6, 2021 in the Korean Intellectual Property Office, the entire contents of which are hereby incorporated by reference.

### BACKGROUND

Embodiments of the inventive concept described herein relate to system for voice authentication through voice recognition and voiceprint recognition.

Recently, as the amendment to the Electronic Signature Act to abolish the superior legal effect of accredited certificates has been passed, the commercialization of mobile IDs that prove identity with information stored in smartphones instead of plastic card-type IDs using block chain-based decentralized ID technology is in progress.

Because the issued mobile employee ID is stored in a block chain that cannot be forged or altered, the record may be transparently managed. In addition, a personal authentication service using block chain-based decentralized ID technology has been used in various fields.

Meanwhile, along with the spread of smart devices, biometric services using human biometric information have been spread. However, as most of the current bio-authentication is made on the premise of using smart devices, it is difficult for the elderly and the disabled, who may be said to be digital blind spots, to use the bio-authentication, and additional investment for bio-authentication may be required. Accordingly, a voice verification service that can use an existing phone channel as it is may provide a very effective authentication service.

Therefore, it is necessary to build/operate a voice authentication center that improves the accuracy and reliability of authentication by using a composite authentication that combines voice authentication and voice recognition technology, and enhances security using block chain technology.

In particular, unlike the bio-authentication center built by the existing KFTC for large financial institutions, it is necessary to provide a service by establishing a private voice authentication center that can be conveniently used by small and medium-sized businesses or individual businesses.

Accordingly, there is a need to provide a method that can easily generate a key for identification when issuing a block chain-based decentralized ID.

### SUMMARY

Embodiments of the inventive concept provide a service after performing identity authentication through voice recognition for each user by matching a key for identification with a voiceprint when issuing a block chain-based decentralized ID.

Objects of the inventive concept may not be limited to the above, and other objects will be clearly understandable to those having ordinary skill in the art from the following disclosures.

According to an embodiment, a voice authentication method through voice recognition and voiceprint recognition by a server includes receiving voice information from a user terminal, generating voiceprint information about a user based on the voice information, when a decentralized ID is issued based on a block chain, generating a private key based on the voiceprint information, and generating a public key based on public information of the user, and performing authentication for the user to generate authentication result information by when a request for authentication for the user is received from an external device.

In this case, the performing of the authentication may include receiving a request for authentication of the user from the external device when the user requests a service from the external device, requesting the user to input the private key through the external device, receiving authentication voice information of the user for the private key input request from the external device, generating authentication voiceprint information for the user based on the authentication voice information, and performing the authentication for the user based on a matching ratio between the voiceprint information and the authentication voiceprint information, thereby generating the authentication result information.

In addition, there may be further provided other methods and other systems to implement embodiments, as well as computer-readable recording media having stored thereon computer programs for executing the methods.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a view illustrating a voice authentication system through voice recognition and voiceprint recognition according to the inventive concept;

FIG. 2 is a block diagram schematically illustrating a voice authentication system through voice recognition and voiceprint recognition according to the inventive concept;

FIG. 3 is a flowchart illustrating a process in which a server according to the inventive concept provides voice authentication through voice recognition and voiceprint recognition;

FIG. 4 is a view illustrating a voice authentication system through voice recognition and voiceprint recognition according to an embodiment of the inventive concept; and

FIG. 5 is a view illustrating a voice authentication system through voice recognition and voiceprint recognition according to another embodiment of the inventive concept.

### DETAILED DESCRIPTION

Advantages and features of embodiments of the inventive concept, and method for achieving thereof will be apparent with reference to the accompanying drawings and detailed description that follows. But, it should be understood that the inventive concept is not limited to the following embodiments and may be embodied in different ways, and that the embodiments are given to provide complete disclosure of the inventive concept and to provide thorough understanding of the inventive concept to those skilled in the art, and the scope of the inventive concept is limited only by the accompanying claims and equivalents thereof.

The terms used in the present disclosure are provided to describe embodiments, not intended to limit the inventive concept. In the present disclosure, singular forms are intended to include plural forms unless the context clearly indicates otherwise. It will be further understood that the terms “comprises,” and/or “comprising,” used herein, specify the presence of stated elements, but do not preclude the presence or addition of one or more other elements. In the present disclosure, like reference numerals indicate like elements, and the term “and/or” indicates each of listed components or various combinations thereof. Terms, such as “first”, “second”, and the like, are for discriminating various components, but the scope is not limited to the terms. The terms are used for discriminating one component from another component. Therefore, the first component mentioned below may be the second component within the technical spirit of the inventive concept.

Unless otherwise defined, all terms used herein (including technical or scientific terms) have the same meanings as those generally understood by those skilled in the art to which the inventive concept pertains. Such terms as those defined in a generally used dictionary are not to be interpreted as having ideal or excessively formal meanings unless defined clearly and specifically.

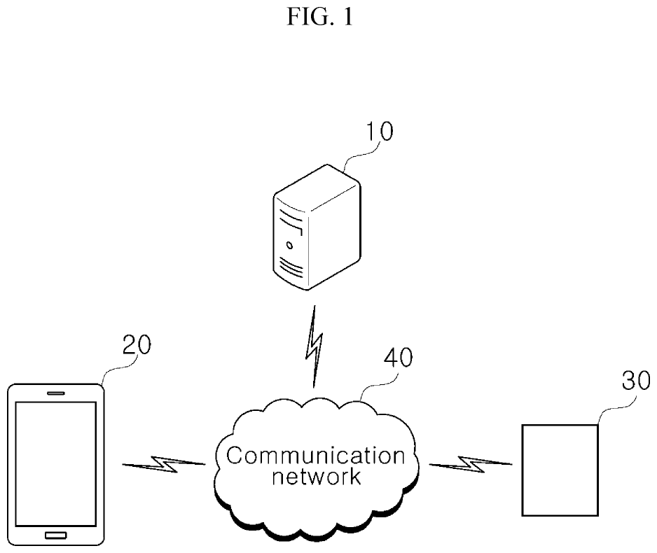

FIG. 1 is a view illustrating a voice authentication system 1 through voice recognition and voiceprint recognition according to the inventive concept.

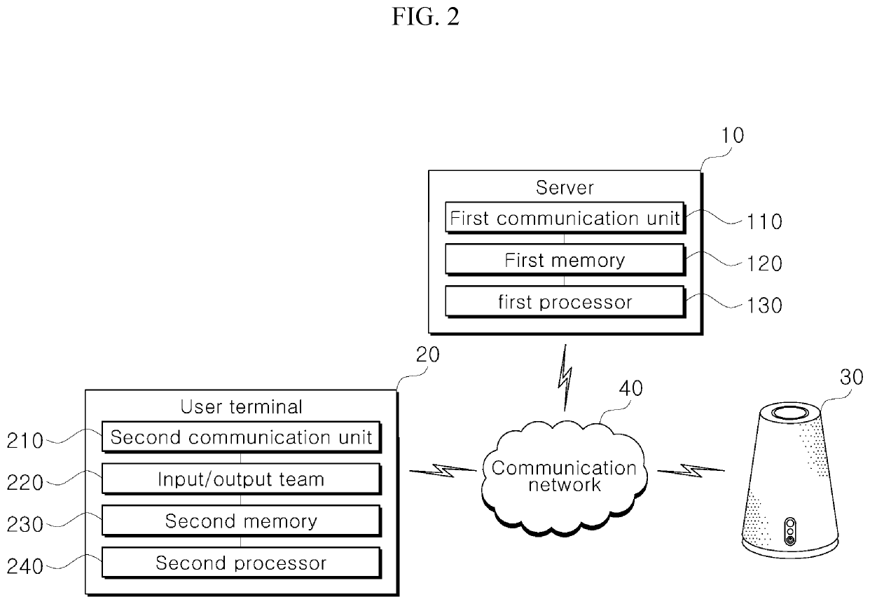

FIG. 2 is a block diagram schematically illustrating the voice authentication system 1 through voice recognition and voiceprint recognition according to the inventive concept.

Referring to FIGS. 1 and 2, the voice authentication system 1 through voice recognition and voiceprint recognition according to the inventive concept may include a server 10, a user terminal 20, an external device 30 and a communication network 40. In this case, the system 1 may include fewer or more components than the components shown in FIG. 1.

After matching the identification key with the voiceprint when issuing a block chain-based decentralized ID to perform identity authentication through voice recognition for each user, the system 1 may provide its service, so that the user may easily perform identity authentication with guaranteed security through his voice to receive the service.

First, the server 10 may include a first communication unit 110, a first memory 120, and a first processor 130. In this case, the server 10 may include a smaller number of components or more components than the components shown in FIG. 2.

The first communication unit 110 may include at least one module that enables wireless communication between the server 10 and a wireless communication system, the server 10 and the user terminal 20, the server 10 and the external device 30, or the server 10 and an external server (not shown). In addition, the first communication unit 110 may include at least one module for connecting the server 10 to one or more networks.

The first memory 120 may store data supporting various functions of the server 10. The first memory 120 may store a plurality of application programs (or applications) driven in the server 10, data for operation of the server 10, and instructions.

In this case, the first memory 120 may store voice information for each user, and may also store voiceprint information for the voice information.

The first processor 130 may generally control the overall operation of the server 10 in addition to the operation related to the application program. The first processor 130 may process signals, data, information, and the like input or output through the above-described components or operate an application program stored in the first memory 120 to provide or process appropriate information or functions to the user.

In addition, the first processor 130 may control at least some of the components described with reference to FIG. 2 in order to drive an application program stored in the first memory 120. Furthermore, in order to drive the application program, the first processor 130 may operate at least two or more of the components included in the server 10 in combination with each other.

The first processor 130 may request to input the voice information corresponding to the voiceprint to be used as the identification key to the user terminal 20 through the first communication unit 110, and may receive the requested voice information from the user terminal 20. In this case, the voice information may be a voice in the form of a sentence or word input by the user through a microphone (not shown) of the user terminal 20. In this case, the sentence or word may be preset by the server 10. That is, the user terminal 20 may guide the user to speak the sentence or word preset by the server 10, and the user may speak the sentence or word according to the guidance.

The first processor 130 may generate voiceprint information for the user based on the voice information. In this case, the first processor 130 may analyze a voice pattern including at least one of tone, gender, age, length, height, and intensity of a human voice through a voice analysis module (not shown), and may visualize the analyzed voice pattern as a pattern like a fingerprint to generate the voiceprint information having a unique property for each individual.

When issuing the decentralized ID based on the block chain, the first processor 130 may generate a private key for user identification based on the voiceprint information, and generate a public key based on the public information of the user.

In addition, the first processor 130 may store the decentralized ID, the private key and the public key through a block chain network in a block chain scheme.

When receiving a request for authentication for the user from the external device 30, the first processor 130 may perform authentication for the user to generate authentication result information.

In detail, when the user inputs the decentralized ID to request a service to the external device 30, the first processor 130 may receive a request for authentication for the user from the external device 30.

In this case, the first processor 130 may request the private key of the user input to the user terminal 20 through the external device 30.

In this case, in the inventive concept, it does not require the input of the existing text form of a private key, but, as described above, the first processor 130 may control to speak the voice corresponding to the voiceprint information to the external device 30 through the user terminal 20, as the private key for identification of the user. The external device 30 may control to allow the user to speak a sentence or word preset by the server 10 described above through the user terminal 20.

The first processor 130 may receive the authentication voice information for the requested voice from the user terminal 20 through the external device 30, and generate the voiceprint information for the user based on the received authentication voice information. In addition, the first processor 130 may authenticate the user based on a matching ratio between the voiceprint information and the authentication voiceprint information.

That is, the first processor 130 may analyze the voice pattern including at least one of a tone, gender, age, length, height, and intensity for the authentication voice information received through the voice analysis module (not shown), and may generate the analyzed voice pattern as the authentication voiceprint information.

In more detail, when the matching ratio between the voice pattern in the voiceprint information and the voice pattern in the authentication voiceprint information is equal to or greater than a preset threshold, the first processor 130 may generate authentication result information in which authentication of the user may be successful because it is the same person. To the contrary, when the matching ratio between the voice pattern in the voiceprint information and the voice pattern in the authentication voiceprint information is less than the preset threshold, the first processor 130 may generate authentication result information in which authentication of the user fails because it is not the same person.

Next, the user terminal 20 may be any type of handheld-based wireless communication device capable of being connected to the server 10, the external device 30, and the like through a network, and may be capable of inputting and outputting various information through a screen, such as a mobile phone, a smart phone, a personal digital assistant (PDA), a portable multimedia player (PMP), a tablet PC, and the like.

In this case, the user terminal 20 may include a second communication unit 210, an input/output unit 220, a second memory 230, and a second processor 240. In this case, the user terminal 20 may include fewer or more components than the components shown in FIG. 2.

The second communication unit 210 may include at least one module capable of wireless communication between the user terminal 20 and each wireless communication system, between the user terminal 20 and the server 10, between the user terminal 20 and the external device 30, or between the user terminal 20 and an external server (not shown). In addition, the second communication unit 210 may include one or more modules for connecting the user terminal 20 to one or more networks.

The second input/output unit 220 may include a touch key, a mechanical key, and the like for receiving information from a user, or a display module (not shown), a sound input/output module (not shown), a haptic module (not shown), and a light output module (not shown) for generating an output related to visual, auditory or tactile sense to a user.

In this case, the sound input/output module (not shown) may include a microphone (not shown) which processes an external sound signal as electrical voice data. The voice data may be utilized in various manners according to a function (or an application program being executed) being performed by the user terminal 20. Meanwhile, various noise removal algorithms for removing noise generated in the process of receiving an external sound signal may be implemented in a microphone (not shown).

The second memory 230 may store data supporting various functions of the user terminal 20. The second memory 230 may store a plurality of application programs (or applications) driven in the user terminal 20, data for operation of the user terminal 20, and instructions. At least some of these application programs may be downloaded from an external server (not shown) through wireless communication.

In addition, at least some of such application programs may exist for a basic function of the user terminal 20. Meanwhile, the application program may be stored in the second memory 230, installed in the user terminal 20, and driven to perform an operation (or function) of the user terminal 20 by the second processor 240.

The second memory 230 may store a block chain electronic wallet including the decentralized ID, the private key, and the public key provided from the server 10.

In addition to the operation related to the application program, the second processor 240 may control the overall operation of the user terminal 20 in general. The second processor 240 may process signals, data, information, and the like input or output through the above-described components, or may provide or process appropriate information or functions to the user by driving an application program stored in the second memory 230.

In addition, the second processor 240 may control at least some of the components discussed with reference to FIG. 2 in order to drive an application program stored in the second memory 230. Furthermore, the second processor 240 may operate by combining at least two or more of the components included in the user terminal 20 with each other in order to drive the application program.

The external device 30 may be an artificial intelligence-based speaker. The external device 30 may store the voices of the users, and when the first user inputs a decentralized ID for a service request, the external device 30 may request authentication for the user from the server 10.

Thereafter, the external device 30 may request the user to input the private key according to the request of the server 10, receive the authentication voice information of the user according to the request, and transmit it to the server 10.

In addition, the external device 30 may receive the authentication result information for the user from the server 10, and provide a corresponding service according to the authentication result information to the user.

For example, the external device 30 may check the log record of the user when authentication is completed as the user is the same person according to the authentication result information. In addition, when the user is a user who searches for a lot of movies through the external device 30, the external device 30 may provide a movie-related service.

As another example, the external device 30 may determine whether the user is a member when the user requests a service for the first time according to the authentication result information, provide the first service when membership registration proceeds according to whether the user is registered as a member, and proceed with a membership registration service when the membership registration is not in progress.

The communication network 40 may transmit and receive various types of information between the server 10, the user terminal 20 and the external device 30. The communication network 40 may use various types of communication networks, for example, a wireless communication scheme such as wireless LAN (WLAN), Wi-Fi, Wibro, Wimax, high speed downlink packet access (HSDPA), and the like, or a wired communication scheme such as Ethernet, xDSL (ADSL, VDSL), hybrid fiber coax (HFC), fiber to the curb (FTTC), fiber to the home (FTTH), and the like.

Meanwhile, the communication network 40 is not limited to the communication schemes presented above, and may include all types of communication schemes that have been widely known or will be developed later in addition to the above-mentioned communication schemes.

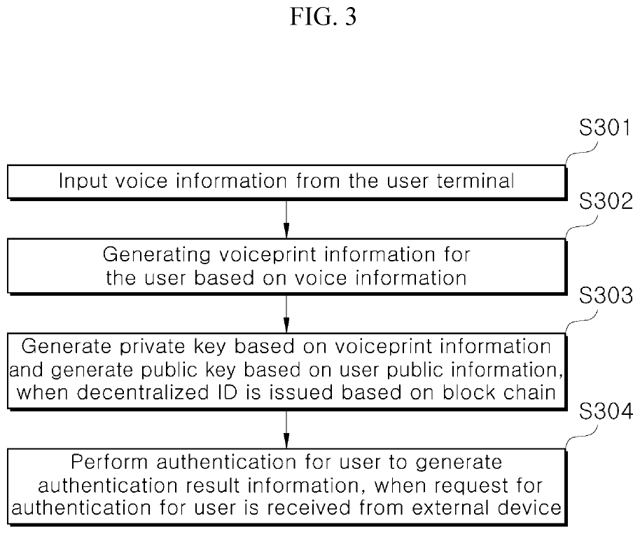

FIG. 3 is a flowchart illustrating a process in which the server 10 according to the inventive concept provides voice authentication through voice recognition and voiceprint recognition. Hereinafter, all operations of the server 10 may be equally performed by the first processor 130.

Referring to FIG. 3, in operation S301, the server 10 may receive voice information from the user terminal 20.

The server 10 may request the user terminal 20 to input voice information corresponding to a voiceprint to be used as a key for identity verification, and may receive the requested voice information from the user terminal 20.

In operation S302, the server 10 may generate voiceprint information for the user based on the voice information.

The server 10 may analyze a voice pattern including at least one of tone, gender, age, length, height, and intensity of a human voice through a voice analysis module (not shown), and may visualize the analyzed voice pattern as a pattern like a fingerprint to generate the voiceprint information having a unique property for each individual.

In operation S303, when the server 10 issues the decentralized ID based on the block chain, the server 10 may generate a private key based on the voiceprint information and generate a public key based on the user's public information.

In more detail, when issuing the decentralized ID based on the block chain, the server 10 may generate the private key for user identification based on the voiceprint information, and generate the public key, which is provided to the external device 30, based on the public information of the user. In addition, the server 10 may store the decentralized ID, the private key and the public key through a block chain network in a block chain scheme.

In operation S304, when receiving a request for authentication for the user from the external device 30, the server 10 may perform authentication for the user to generate authentication result information.

In detail, when the user inputs the decentralized ID to request a service to the external device 30, the server 10 may receive a request for authentication for the user from the external device 30.

In this case, the server 10 may request input of the private key of the user to the user terminal 20 through the external device 30.

In this case, in the inventive concept, it does not require the input of the existing text form of a private key, but, as described above, the server 10 may control to speak the voice corresponding to the voiceprint information to the external device 30 through the user terminal 20, as the private key for identification of the user. The external device 30 may control to allow the user to speak a sentence or word preset by the server 10 described above through the user terminal 20.

The server 10 may receive the authentication voice information for the requested voice from the user terminal 20 through the external device 30, and generate the voiceprint information for the user based on the received authentication voice information. In addition, the server 10 may authenticate the user based on a matching ratio between the voiceprint information and the authentication voiceprint information.

That is, the server 10 may analyze the voice pattern including at least one of a tone, gender, age, length, height, and intensity for the authentication voice information received through the voice analysis module (not shown), and may generate the analyzed voice pattern as the authentication voiceprint information.

In more detail, when the matching ratio between the voice pattern in the voiceprint information and the voice pattern in the authentication voiceprint information is equal to or greater than a preset threshold, the server 10 may generate authentication result information in which authentication of the user may be successful because it is the same person. To the contrary, when the matching ratio between the voice pattern in the voiceprint information and the voice pattern in the authentication voiceprint information is less than the preset threshold, the server 10 may generate authentication result information in which authentication of the user fails because it is not the same person.

Although FIG. 3 illustrates operations S301 to S304 sequentially executed, this is merely illustrative of the technical idea of the present embodiment. Those of ordinary skill in the art to which the embodiment pertains may change the order described in FIG. 3 or execute one or more of operations S301 to S304 in parallel within a range that does not depart from the essential features of the embodiment. Because various modifications and variations may be applied to the embodiment, FIG. 3 is not limited to a chronological order.

The method according to the inventive concept described above may be implemented as a program (or application) to be executed in combination with a server, which is hardware, and stored in a medium.

As described above, in order for a computer to read a program recorded on a recording medium and execute the methods implemented by a program, the program may include code coded in a computer language, such as C, C++, JAVA, machine language, and the like, which can be read by a processor (CPU) of a computer through a device interface of the computer. The code may include a functional code related to a function or the like that defines the functions necessary to execute the methods and the code may include an execution procedure related control code necessary for a processor of the computer to execute the functions according to a predetermined procedure. In addition, such code may further include memory reference related code as to whether additional information or media needed to cause the processor of the computer to execute the aforementioned functions should be referred to at a location (address) of the internal or external memory of the computer. In addition, when the processor of the computer needs to communicate with any other computer or server at a remote location in order to execute the functions, the code may further include communication-related codes for how to communicate with any other remote computer or server using the communication module of the computer, and what information or media to transmit/receive during communication.

The storing medium is not a medium for storing data for a short time such as a register, a cache, a memory, and the like, but means a medium that semi-permanently stores data and is capable of being read by a device. In detail, examples of the storing medium include ROM, RAM, CD-ROM, magnetic tape, floppy disk, optical data storage, and the like, but are not limited thereto. That is, the program may be stored in various recording media on various servers to which the computer can access, or on various recording media on the user's computer. In addition, the medium may be dispersed throughout computer systems connected via networks and may store a computer-readable code in a dispersion manner

The operations of a method or algorithm described in connection with the embodiments of the inventive concept may be embodied directly in hardware, in software modules executed in hardware, or in a combination of both. The software module may reside in a random access memory (RAM), a read only memory (ROM), an erasable programmable ROM (EPROM), an electrically erasable programmable ROM (EEPROM), a flash memory, a hard disk, a removable disk, or any form of computer readable recording medium known in the art to which the invention pertains.

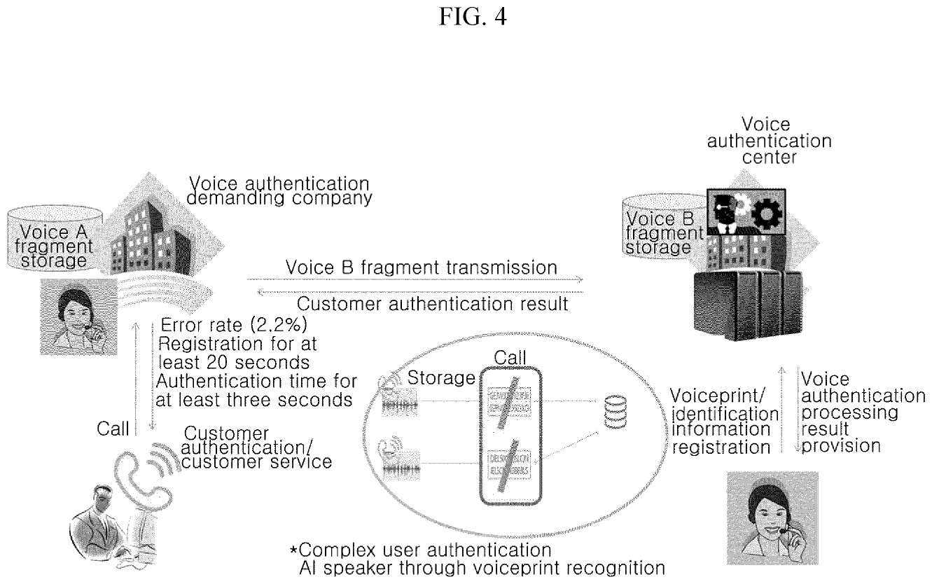

FIG. 4 is a view illustrating a voice authentication system through voice recognition and voiceprint recognition according to an embodiment of the inventive concept.

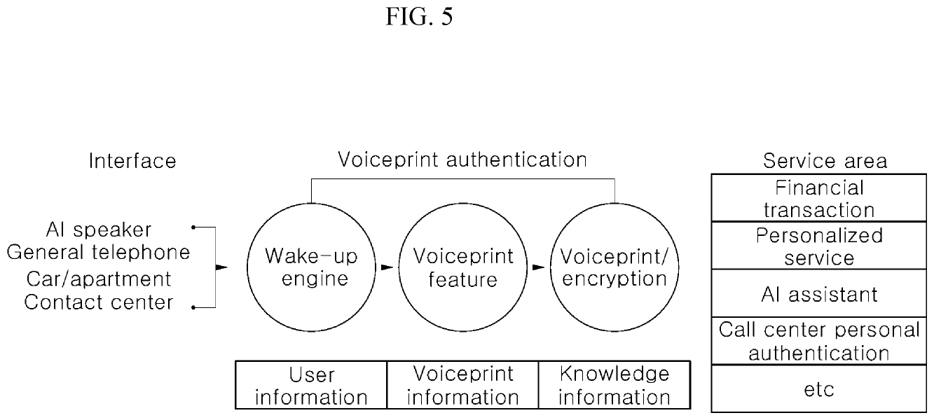

FIG. 5 is a view illustrating a voice authentication system through voice recognition and voiceprint recognition according to another embodiment of the inventive concept.

When a customer calls a customer center, the server 10 may provide the counselor for the first verification of whether the customer is correct based on the voiceprint authentication, thereby enabling the counselor to ask an additional question.

After voice authentication, when the customer is identified, the server 10 may display blue, yellow when it is not, and red when it is not very good, for guidance. Then, the server 10 may confirm the customer information once again to proceed.

The server 10 may proceed by verifying the identity through the complex voice-print authentication in the case of important tasks such as money after confirming that it is the user's voice based on the complex voiceprint authentication, for example, the combination of voiceprint authentication and voice-print recognition.

The server 10 may maximize the accuracy of authentication by utilizing the complex authentication (combination of voiceprint authentication and voiceprint recognition).

As an example, when a counselor receives a customer call through a counselor terminal, the counselor may say, for example, “Hello, this is service center A. greetings. Could you please tell me your name and date of birth?”.

In this case, the user may respond with “TOM, Aug. 1, 1970” through the user terminal.

In this case, the server 10 may authenticate whether the user is exactly TOM born in 1970 with only the response. The server 10 may simultaneously execute ID and Verification.

In this case, the counselor may ask an additional registration question in order to proceed with a more important service.

As an example, the counselor may ask a question, “Tell your elementary school name,” among a plurality of pre-registered questions through the counselor terminal.

In this case, the user may respond with “B elementary school” through the user terminal.

In this case, the server 10 may secure a high level of reliability through the response obtained from the user.

In this case, the voice registration time may be at least 20 seconds, and the authentication time may be within 3 seconds to provide the result to the counselor.

The server 10 may allow the user to register his/her voiceprint through a mobile app, a web and an existing phone channel

In this case, when the user registers the voiceprint in advance, the server 10 may provide a voiceprint registration service such that the user can quickly and conveniently perform identity authentication and important transactions only with his or her own voice without a separate authentication process. In this case, the service may be a promotion inducing the user's pre-voice registration.

The server 10 may perform coding, encryption and division of a voiceprint. The server 10 may perform the coding, encryption and division of a voice print and distribute them to block chain-based partner servers.

In this case, the server of an affiliated company may further increase the safety as a block chain node.

A voiceprint authentication distribution server (not shown) may easily use the voice authentication function by simply connecting the authentication distribution server to an existing phone system. In addition, the voiceprint authentication distribution server may be encrypted, fragmented and decentralized to be configured as a light and secure server.

The server 10 may provide a connectionless authentication service. In this case, according to a degree of importance of the service, the server 10 may implement first level authentication only with a simple name and voice, and second level authentication that uses even personal knowledge information for important services (financial, personal information correction, and the like), thereby increasing security.

In this case, in the server 10, when the authentication operation is required, after authentication is confirmed, the control is switched to an existing phone system, so that additional load or delay for authentication does not occur.

In addition, to allow the server 10 to provide safe and reliable service together with a number of affiliated companies, a voice authentication center system may be configured by using micro service architecture (MSA) and container technology.

The server 10 may include the technologies, as main component technologies, such as voice feature extraction, feature tokening (encoding technology), encoding & decoding (encryption/decryption, separation/combination technology), block chain storage and operation technology, voice verification (voice authentication) technology, voice recognition (STT processing of speech content), micro service architecture (MSA, container technology, and the like.

As described above, according to the inventive concept, a service may be provided after matching the identification key with the voiceprint when issuing a block chain-based decentralized ID to perform identity authentication through voice recognition for each user, so that the user may easily perform identity authentication with guaranteed security through his voice to receive the service.

In addition, according to the inventive concept, because it can utilize the existing phone system as it is, it can help those in the digital blind spot, and it can provide a high level of authentication service with a small investment cost.

In addition, according to the inventive concept, by providing a voice-based complex authentication solution, it is possible to identify multiple users of an AI speaker by utilizing the speaker identification and voice authentication functions of SVID, thereby providing a service that enables high-security work processing.

In addition, effects of the inventive concept may not be limited to the above, and other effects will be clearly understandable to those having ordinary skill in the art from the detailed description.

While the inventive concept has been described with reference to embodiments, it will be apparent to those skilled in the art that various changes and modifications may be made without departing from the spirit and scope of the inventive concept. Therefore, it should be understood that the above embodiments are not limiting, but illustrative.

What is claimed is:

1. A voice authentication method through voice recognition and voiceprint recognition by a server, the voice authentication method comprising:
receiving voice information from a user terminal;
generating voiceprint information about a user based on the voice information;
when a decentralized ID is issued based on a block chain, generating a private key based on the voiceprint information, and generating a public key based on public information of the user; and
performing authentication for the user to generate authentication result information when a request for authentication for the user is received from an external device.

2. The voice authentication method of claim 1, wherein the performing of the authentication includes:
receiving a request for authentication of the user from the external device when the user requests a service from the external device;
requesting the user to input the private key through the external device;
receiving authentication voice information of the user for the private key input request from the external device;
generating authentication voiceprint information for the user based on the authentication voice information; and
performing the authentication for the user based on a matching ratio between the voiceprint information and the authentication voiceprint information, thereby generating the authentication result information.
